(19) United States
(12) Patent Application Publication
(10) Pub. No.: US 2025/0383577 A1
(43) Pub. Date: Dec. 18, 2025

(54) OPTICAL DEVICE AND OPTICAL TRANSMISSION APPARATUS USING THE SAME

(71) Applicant: SUMITOMO OSAKA CEMENT CO., LTD., Tokyo (JP)

(72) Inventors: Kyohei HASEGAWA, Tokyo (JP); Kei KATO, Tokyo (JP)

(21) Appl. No.: 18/832,328

(22) PCT Filed: Mar. 31, 2022
(86) PCT No.: PCT/JP2022/016795

§ 371 Date: Feb. 4, 2025

(51) Int. Cl. G02F 1/21; G02F 1/225

(52) U.S. Cl. CPC G02F 1/212; G02F 1/225; G02F 2203/21

(57) ABSTRACT

In order to provide an optical device that can increase the cross-sectional area of the heat transfer path from the heat generation element serving as a heat source to the heat dissipation unit compared to the conventional configuration, and that can efficiently dissipate heat from the heat generation element, and an optical transmission apparatus using the same, an optical device 2, comprising: a modulation element unit 10 including an optical modulation element 15; a heat generation element 20; a heat generation element pedestal 31 on which the heat generation element 20 is mounted; and a housing 40 that accommodates the heat generation element pedestal 31 inside there, wherein the heat generation element pedestal 31 has a mounting surface on which the heat generation element 20 is mounted and a mounting surface to be mounted on the housing 40, and the area of the mounting surface on which the heat generation element 20 is mounted is smaller than the area of the mounting surface to be mounted on the housing 40.

### FIELD OF THE INVENTION

The present invention relates to an optical device and an optical transmission apparatus using the same, particularly to an optical device used for optical communication and the like in which a heat generation element, an optical modulation element, an optical component, an electronic component and the like are implemented/integrated inside of a small housing, and an optical transmission apparatus using the same.

### BACKGROUND ART

As a conventional technology, there is an optical device having a semiconductor modulator which is an optical modulation element and a driver element built therein. In such an optical device, in order to perform stable operation, an optical modulation element is configured to be mounted on a temperature control element (Thermo-Electric Cooler: TEC) to control the temperature. Therefore, the driver element and the temperature control element are independently mounted on the bottom of the housing so that the driver element and the temperature control element do not affect each other in temperature.

Specific examples of the optical device 100 disclosed in Patent Document 1 are shown in FIGS. 14 and 15. In the optical device 100, a driver element 110, a heat sink 120, an optical modulation element 130, a TEC 140, a plurality of optical components 150, an electronic component 160, and the like are integrated in a housing 200. The driver element 110 is mounted on the bottom surface 200E of the housing via

the heat sink 120, and the optical modulation element 130 is mounted on the bottom surface 200E of the housing via the TEC 140 and the carrier 170. The bottom surface 200E of the housing is a heat dissipation surface of the optical device 100, and the heat generated by the driver element 110 is dissipated to the outside of the housing 200 through the heat sink 120 and the bottom surface 200E of the housing. The heat sink 120 has a rectangular parallelepiped shape, and its cross-sectional area (length×width) is almost equal to the area of the driver element 110.

### CITATION LIST

### Patent Literature

Patent Document 1: Japanese Patent Application Publication No. 2021-509483

### SUMMARY OF THE INVENTION

### Technical Problem

An integrated optical device in which a heat generation element such as a driver element is arranged in a housing is required to be miniaturized, and it is also necessary to reduce the area of the mounting surface of a pedestal such as a heat sink on which the heat generation element is mounted. The heat generation element includes high frequency electronic components such as a laser light source, an optical amplifier, and a driver element.

The power consumption of the driver element used in the optical device is about a few watts (2 to 5 W), and if heat dissipation is insufficient, the temperature of the driver element itself will exceed 100° C. due to driving. Therefore, particularly in an optical device in which a driver element is integrated, it is a major problem to dissipate heat generated by the driver element. When the area of the mounting surface of the pedestal is small as in the optical device disclosed in Patent Document 1, the area of the contact surface of the pedestal that contacts the bottom of the housing having the heat dissipating surface is also small, thereby making efficient heat dissipation difficult. Further, in recent years, there has been a high demand for reducing the thickness of the entire optical device, and in this case, the thickness of the bottom of the housing is also reduced, so that there is a problem that heat diffusion at the bottom of the housing is not performed and the heat dissipation surface cannot be effectively utilized.

Normally, the driver element is configured to use differential signals as inputs when it is compatible with coherent communication. On the other hand, the output of the driver element is selected from either a differential signal or a single-ended signal according to the signal type required by the optical modulation element, and is input to the optical modulation element. The power consumption and heat generation amount of the driver element tend to increase as the communication speed increases, for example, they become larger as the modulation symbol rate increases to 96 Gbaud, 128 GBaud, or faster communication speed beyond that. Further, in the case of a configuration using a single-ended output driver element such as an LN modulator using an X-plate LN, the power consumption and heat generation become larger than those of a differential signal output in order to increase the output amplitude of the driver element, thus the improvement of heat dissipation becomes a more important problem. Further, the higher the modulation symbol rate, the greater the problem of signal attenuation due to electrical wiring. For this reason, it is being considered to integrate not only drivers but also higher-performance high-frequency electronic circuits such as signal processing and waveform shaping in the modulator, in which case the power consumption and heat generation will be higher, thereby making improvement of heat dissipation more important.

The present invention has been made to solve such conventional problems, and it is the object of the present invention to provide an optical device that can increase the cross-sectional area of the heat transfer path from the heat generation element serving as a heat source to the heat dissipation unit compared to the conventional configuration, and that can efficiently dissipate heat from the heat generation element, and an optical transmission apparatus using the same.

### Means to Solve Problems

In order to solve the above problems, the optical device according to the present invention is an optical device, comprising: a modulation element unit including an optical modulation element; a heat generation element; a heat generation element pedestal on which the heat generation element is mounted; and a housing that accommodates the heat generation element pedestal inside there, wherein the heat generation element pedestal has a mounting surface on which the heat generation element is mounted and a mounting surface to be mounted on the housing, and the area of the mounting surface on which the heat generation element is mounted is smaller than the area of the mounting surface to be mounted on the housing.

By this configuration, the optical device according to the present invention can take a larger area in contact with the heat generation element pedestal with the housing functioning as a heat dissipating unit as compared to the conventional case. As a result, in the optical device according to the present invention, the cross-sectional area of the heat transfer path from the heat generation element as a heat source to the heat dissipation unit can be made larger than that of the conventional configuration, so that the heat generated by the heat generation element can be efficiently dissipated to the outside. Further, since the optical device according to the present invention has improved

heat dissipation as compared to the conventional case, it is possible to increase the selection of materials used for the heat generation element pedestal. For example, the optical device according to the present invention can achieve heat dissipation equivalent to or better than that of conventional materials, even if a material having lower thermal conductivity than conventional materials but at a lower cost is selected. In addition, it is possible to improve the mechanical reliability of the device by selecting a material that takes into account the coefficient of linear expansion of the heat generation element and the housing.

Further, in the optical device according to the present invention, the modulation element unit may be configured to be mounted on the heat generation element pedestal.

Further, in the optical device according to the present invention, the modulation element unit may be configured to be mounted on a modulation element unit pedestal separate from the heat generation element pedestal.

Further, in the optical device according to the present invention, the heat generation element may be configured to be mounted on the heat generation element pedestal so that the entire surface of the region facing the heat generation element pedestal on the lower surface thereof is in contact with the heat generation element pedestal, and the modulation element unit is mounted so that a part thereof is in contact with the heat generation element pedestal.

By this configuration, the optical device according to the present invention is provided with a structure in which the modulation element unit is mounted on the heat generation element pedestal so that only a part of the modulation element unit is in contact with the heat generation element pedestal, thereby making it possible to reduce the area where the modulation element unit is in contact with the heat generation element pedestal. As a result, the optical device according to the present invention can efficiently dissipate the heat generated by the heat generation element to the outside, and further prevent the heat of the heat generation element from being transferred to the optical modulation element, reduce the thermal influence to the modulation unit of the optical modulation element and stabilize the modulation characteristics of the optical modulation element.

Further, in the optical device according to the present invention, the heat generation element may be configured to be mounted on the heat generation element pedestal so that the entire surface of the region facing the heat generation element pedestal on the lower surface thereof is in contact with the heat generation element pedestal, and the modulation element unit is mounted so that a part thereof is in contact with the modulation element unit pedestal.

By this configuration, the optical device according to the present invention is provided with a structure in which the modulation element unit is mounted on the modulation element unit pedestal so that only a part of the modulation element unit is in contact with the heat generation element pedestal, thereby making it possible to reduce the area where the modulation element unit contacts the modulation element unit pedestal. As a result, the optical device according to the present invention can efficiently dissipate the heat generated by the heat generation element to the outside, and further prevent the heat of the heat generation element from being transferred to the optical modulation element, reduce the thermal influence to the modulation unit of the optical modulation element and stabilize the modulation characteristics of the optical modulation element.

Further, in the optical device according to the present invention, the heat generation element pedestal may be configured to extend below the modulation element unit.

By this configuration, the optical device according to the present invention can take a larger area in contact with the heat generation element pedestal with the heat dissipating unit as compared to the conventional case. As a result, in the optical device according to the present invention, the cross-sectional area of the heat transfer path from the heat generation element as a heat source to the heat dissipation unit can be made larger than that of the conventional configuration, so that the heat generated by the heat generation element can be efficiently dissipated to the outside.

Further, in the optical device according to the present invention, in the heat generation element pedestal, one or more grooves or holes may be configured to be provided between the region where the heat generation element is mounted and the region where the modulation element unit is mounted.

By this configuration, the optical device according to the present invention is configured to be provided with a void, such as a groove or a hole in the path where heat is transferred from the heat generation element, and between the region where the heat generation element is mounted and the region where the modulation element unit is mounted. As a result, the optical device according to the present invention can efficiently dissipate the heat generated by the heat generation element to the outside, and further prevent the heat of the heat generation element from being transferred to the optical modulation element, reduce the thermal influence to the modulation unit of the optical modulation element and stabilize the modulation characteristics of the optical modulation element.

Further, in the optical device according to the present invention, one or more grooves or gaps may be configured to be provided between the heat generation element pedestal and the modulation element unit pedestal.

By this configuration, the optical device according to the present invention is configured to be provided with a void, such as a groove or a gap in the path where heat is transferred from the heat generation element, and between the heat generation element pedestal and the modulation element unit pedestal. As a result, the optical device according to the present invention can efficiently dissipate the heat generated by the heat generation element to the outside, and further prevent the heat of the heat generation element from being transferred to the optical modulation element, reduce the thermal influence to the modulation unit of the optical modulation element and stabilize the modulation characteristics of the optical modulation element.

Further, in the optical device according to the present invention, the heat generation element pedestal and the modulation element unit pedestal may be configured to be separated from each other.

By this configuration, the optical device according to the present invention can further reduce the transfer of heat from the heat generation element to the modulation element unit pedestal and the modulation element unit through the heat generation element pedestal, by providing the heat generation element pedestal and the modulation element unit pedestal as separate pedestal units that are separated from each other.

Further, in the optical device according to the present invention, a material having a thermal conductivity lower than that of the heat generation element pedestal may be configured to be arranged in the one or more grooves.

By this configuration, the optical device according to the present invention can effectively dissipate the heat of the heat generation element to the outside, further prevent the heat from being transferred to the optical modulation element, reduce the thermal influence to the modulation unit of the optical modulation element, and stabilize the modulation characteristics of the optical modulation element, since a component constituted by a material having a lower thermal conductivity than that of the heat generation element pedestal is arranged in the path where heat is transferred from the heat generation element.

Further, in the optical device according to the present invention, a material having a thermal conductivity lower than that of the heat generation element pedestal may be configured to be arranged between the modulation element unit and the heat generation element pedestal.

By this configuration, in the optical device according to the present invention a material having a thermal conductivity lower than that of the heat generation element pedestal is configured to be arranged between the modulation element unit and the heat generation element pedestal. This means that the optical device according to the present invention can effectively dissipate the heat of the heat generation element to the outside, further prevent the heat from being transferred to the optical modulation element, reduce the thermal influence to the modulation unit of the optical modulation element, and stabilize the modulation characteristics of the optical modulation element, since a component constituted by a material having a lower thermal conductivity than that of the heat generation element pedestal is inserted in the path where heat is transferred from the heat generation element.

Further, in the optical device according to the present invention, the heat generation element may be a driver element for driving the optical modulation element.

By this configuration, since the optical device according to the present invention has excellent heat dissipation, even if a driver element with a single-ended signal output having a large power consumption and heat generation amount is mounted, heat transfer can be reduced so that the adjacent modulation element unit does not become hot, thereby making it possible to stably operate the modulation element unit.

Further, in the optical device according to the present invention, the heat generation element pedestal may be configured to be integrated with the bottom wall of the housing by the same material.

By this configuration, the optical device according to the present invention can eliminate the need to join and fix the heat generation element pedestal to the bottom wall by integrating the bottom wall that function as the heat dissipating unit and the heat generation element pedestal. Therefore, the optical device according to the present invention can more efficiently dissipate the heat generated by the heat generation element since the decrease in heat transfer at the joint between the bottom wall and the heat generation element pedestal is prevented.

Further, the optical transmission apparatus according to the present invention is configured to be comprising any of the above optical devices and an electronic circuit that outputs a modulation signal that causes the optical device to perform a modulation operation.

### Effect of the Invention

The present invention provides an optical device that can increase the cross-sectional area of the heat transfer path from the heat generation element serving as a heat source to the heat dissipation unit compared to the conventional configuration, and that can efficiently dissipate heat from the heat generation element, and an optical transmission apparatus using the same.

### BRIEF DESCRIPTION OF DRAWINGS

FIG. 1 is a schematic plan view and a schematic cross-sectional view showing the configuration of an optical device according to the first embodiment of the present invention.

FIG. 2A is a side view and a plan view showing an example of mounting the heat generation element on the heat generation element pedestal in the optical device of FIG. 1.

FIG. 2B is a side view and a plan view showing an example of mounting the heat generation element on the heat generation element pedestal in the optical device of FIG. 1.

FIG. 3 is a schematic plan view and a schematic cross-sectional view showing a configuration of an optical device according to the second embodiment of the present invention.

FIG. 4 is a schematic plan view and a schematic cross-sectional view showing a configuration of an optical device according to the third embodiment of the present invention.

FIG. 5 is a schematic plan view and a schematic cross-sectional view showing a configuration of an optical device according to the fourth embodiment of the present invention.

FIG. 6 is a plan view showing a configuration of a modulation unit of the optical device of FIG. 5

FIG. 7 is a schematic plan view and a schematic cross-sectional view showing a configuration of an optical device according to the fifth embodiment of the present invention.

FIG. 8A is a schematic cross-sectional view showing other configuration of the optical device according to the fifth embodiment of the present invention.

FIG. 8B is a schematic cross-sectional view showing other configuration of the optical device according to the fifth embodiment of the present invention.

FIG. 8C is a schematic cross-sectional view showing other configuration of the optical device according to the fifth embodiment of the present invention.

FIG. 8D is a schematic cross-sectional view showing other configuration of the optical device according to the fifth embodiment of the present invention.

FIG. 9 is a schematic plan view and a schematic cross-sectional view showing a configuration of an optical device according to the sixth embodiment of the present invention.

FIG. 10 is a schematic plan view and a schematic cross-sectional view showing a configuration of an optical device according to the seventh embodiment of the present invention.

FIG. 11 is a schematic cross-sectional view showing other configuration of the optical device according to the seventh embodiment of the present invention.

FIG. 12 is a schematic plan view and a schematic cross-sectional view showing a configuration of an optical device according to the eighth embodiment of the present invention.

FIG. 13 is a diagram showing a configuration of an optical transmission apparatus according to the ninth embodiment of the present invention.

FIG. 14 is a plan view of a conventional optical device.

FIG. 15 is a cross-sectional view of an optical device along lines III-III of FIG. 14.

### DETAILED DESCRIPTION OF EMBODIMENTS

Hereinafter, the embodiment of the optical device and the optical transmission apparatus using the same according to the present invention will be described using drawings.

### First Embodiment

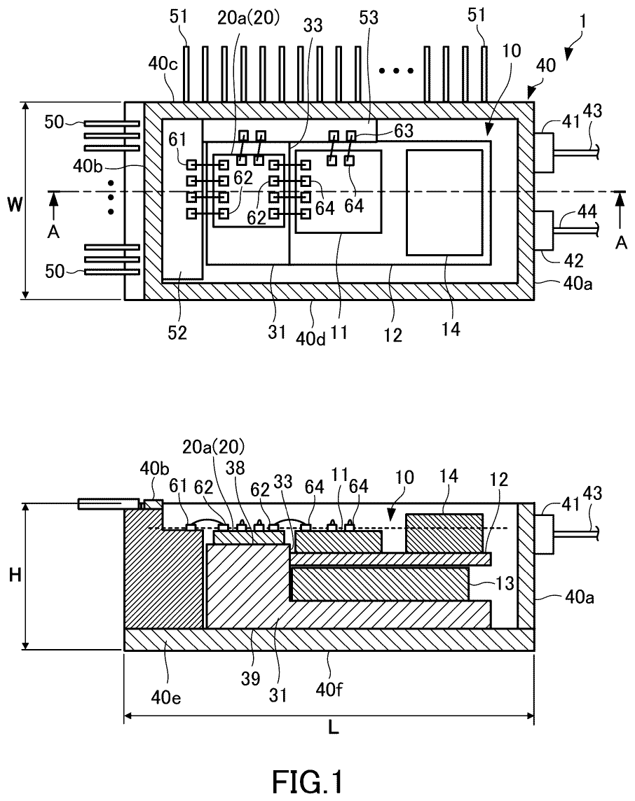

The upper part of FIG. 1 is a schematic plan view of the optical device 1 according to the first embodiment of the present invention. The lower part of FIG. 1 is a schematic cross-sectional view of the optical device 1 along the line A-A of the upper part of FIG. 1.

The optical device 1 shown in FIG. 1 comprises a modulation element unit 10, a heat generation element 20, and a heat generation element pedestal 31 on which the heat generation element 20 is mounted in a housing 40. The modulation element unit 10 includes an optical modulation element 11, a submount 12, and a temperature control element 13.

The optical modulation element 11 in the present embodiment is a Mach-Zehnder type modulator constituted by, for example, a dielectric material such as lithium niobate (LiNbO₃: hereinafter referred to as LN), lithium tantalate (LiTaO₃), lead lanthanum zirconate titanate (PLZT), a material having an electro-optical effect, such as an EO polymer, or a semiconductor such as InP, Si, or GaAs. In the modulator, an optical wave guide through which light waves propagate and a modulation electrode for performing modulation and bias point control are formed on the substrate.

The temperature control element 13 is, for example, TEC, and is mounted on the heat generation element pedestal 31. The submount 12 is mounted on the temperature control element 13. The optical modulation element 11 is mounted on the temperature control element 13 via the submount 12. Further, an optical component 14 such as a lens is mounted on the submount 12. The temperature of the optical modulation element 11 is kept constant by the temperature control element 13 in order to stabilize its modulation characteristics.

The heat generation element 20 is an element that generates heat when driving a laser light source, an optical amplifier, a high frequency electronic component, and the like. Hereinafter, the case where the heat generation element 20 is a high frequency electronic component, particularly the driver element 20a, will be mainly described as an example.

The driver element 20a is for driving the optical modulation element 11, and the electrode pad 62 of the driver element 20a is connected to the electrode pad 64 of the optical modulation element 11 by means of such as, metal wire bonding or flip chip bonding, for example. The driver element 20a is configured to amplify the externally input modulation signal and convert it into a modulation signal having a suitable intensity for providing to the optical modulation element 11.

The driver element 20a is constituted by, for example, a semiconductor compound such as InP, GaAs, SiGe, or Si, and the like, and its coefficient of linear expansion α is, for example, about 2.62×10⁻⁶/K. Further, the size of the driver element 20a is about 2 mm×4 mm.

Normally, the driver element 20a is configured to use differential signals as inputs when it is compatible with coherent communication. On the other hand, the output of the driver element 20a is selected from either a differential signal or a single-ended signal according to the signal type required by the optical modulation, and is input to the optical modulation element unit 10. The power consumption and heat generation amount of the driver element 20a tend to increase as the communication speed increases, for example, they become larger as the modulation symbol rate increases to 96 Gbaud, 128 GBaud, or faster communication speed beyond that. Further, when the driver element 20a outputs a single-ended signal, for example, as in the case of an LN modulator using an X-plate LN, the power consumption and heat generation amount become larger since the output amplitude needs to be larger than in the case of differential signal output, thus the improvement of heat dissipation becomes a bigger problem.

Hereinafter, the configuration of the housing 40 and the heat generation element pedestal 31 for improving the heat dissipation of the heat generation element 20 such as the driver element 20a will be described.

The housing 40 is made of, for example, ceramic, Kovar, or SUS, and accommodates a modulation element unit 10, a heat generation element 20, and a heat generation element pedestal 31. The housing 40 comprises four side walls 40a, 40b, 40c, 40d, and a bottom wall 40e. The side walls 40a and 40b extend in the width direction of the housing 40 and face each other. The side walls 40c and 40d face each other and extend in the longitudinal direction of the housing 40. The four side walls 40a, 40b, 40c, and 40d are erected on the bottom wall 40e.

Further, a part of the side walls 40b and 40c is provided with a high frequency input terminal 50 and an electric terminal 51 for inputting/outputting a power source and an electric signal necessary for the operation of the optical modulation element 11 and other elements. The high frequency input terminal 50 is directly connected to, for example, the terminal of the driver element 20a or other elements. Alternatively, the high frequency input terminal 50 is connected to the terminal of the driver element 20a or other elements via the relay board 52 housed in the housing 40 or integrally formed with the side wall 40b. For example, the electrode pad 61 of the relay board 52 is configured to be connected to the electrode pad 62 of the driver element 20a by means of such as metal wire bonding or flip chip bonding.

Further, the electric terminal 51 is directly connected to, for example, the terminal of the optical modulation element 11 or other elements. Alternatively, the electric terminal 51 is connected to the terminals of the optical modulation element 11 or other elements via the relay board 53 housed in the housing 40 or integrally formed with the side wall 40c. For example, the electrode pad 63 of the relay board 53 is configured to be connected to the electrode pad 64 of the optical modulation element 11 by means of such as metal wire bonding or flip chip bonding.

The size of the housing 40 surrounded by the four side walls 40a to 40d and the bottom wall 40e is, for example, a width W of 12 mm or less, a length L of 30 mm or less, and a height H of 5.5 mm or less. Further, the size of the space in which the heat generation element pedestal 31 can be mounted inside the housing 40 is 10 mm or less in width, 20 mm or less in length, and 2.5 mm or less in height.

An optical input assembly 41 and an optical output assembly 42 are attached to the side wall 40a. An input optical fiber 43 for inputting light to the optical modulation element 11 is connected to the optical input assembly 41. An output optical fiber 44 that guides the light output from the optical modulation element 11 to the outside of the housing 40 is connected to the optical output assembly 42. In addition to the optical fiber, the optical input assembly 41 and the optical output assembly 42 include a lens for collimating and condensing light.

The lower surface 40f of the bottom wall 40e is a surface that is caused to come into contact with a heat dissipation unit provided outside of the optical device 1, and functions as a heat dissipation unit that dissipates heat generated from the heat generation element 20. The bottom wall 40e has a thickness of 1 mm or less, and a material having a good thermal conductivity k is used as the material thereof. For example, as the material of the bottom wall 40e, copper (k: 398 W/m·K), aluminum (k: 237 W/m·K), copper tungsten (k: 170 W/m·K) and the like can be used.

The heat generation element pedestal 31 is joined and fixed on the bottom wall 40e of the housing 40, and functions as a heat sink for the heat generation element 20. The heat generation element pedestal 31 can be joined and fixed to the bottom wall 40e by various methods such as welding, soldering, brazing, and bonding with a high heat conductive resin.

By the way, if there is a large difference between the coefficient of linear expansion of the modulation element unit 10, the heat generation element 20 and the bottom wall 40e of the housing 40 and the coefficient of linear expansion of the heat generation element pedestal 31, there is a risk that each component itself or the joint surface is damaged. Therefore, the material of the heat generation element pedestal 31 is preferably a material in consideration of the thermal conductivity k, the linear expansion α of the modulation element unit 10 and the heating element 20, or the coefficient of linear expansion of the bottom wall 40e of the housing 40. For example, as the material of the heat generation element pedestal 31, copper (α: 17.7×10⁻⁶/K, k: 398 W/m· K), aluminum (α: 24.58× 10⁻⁶/K, k: 237 W/m· K), copper tungsten (α: 6.5×10⁻⁶/K, k: 170 W/m· K), Kovar (a: 5.12×10⁻⁶/K, k: 17 W/m· K) and the like can be used.

The heat generation element pedestal 31 has an upper surface 38 as a mounting surface on which the heat generation element 20 is mounted and a lower surface 39 as a mounting surface to be mounted on the housing 40. The area of the upper surface 38 on which the heat generation element 20 is mounted is smaller than the area of the lower surface 39 to be mounted on the housing 40.

The heat generation element pedestal 31 extends below the modulation element unit 10, and the heat generation element 20 and the modulation element unit 10 are both mounted on the same heat generation element pedestal 31. Here, the fact that the heat generation element pedestal 31 extends below the modulation element unit 10 means that at least a part of the modulation element unit 10 and the heat generation element pedestal 31 are overlapped, when the heat generation element pedestal 31 on which the modulation element unit 10 is mounted is viewed in a plan view. This means that the heat generation element pedestal 31 is configured with a wider cross-sectional area of the heat transfer path from the heat generation element 20 which is a heat source to the bottom wall 40e compared to the conventional case.

The heat generation element 20 is configured to be mounted on the heat generation element pedestal 31, so that the entire surface of the region facing the upper surface 38 of the heat generation element pedestal 31 on the lower surface thereof is in contact with the heat generation element pedestal 31.

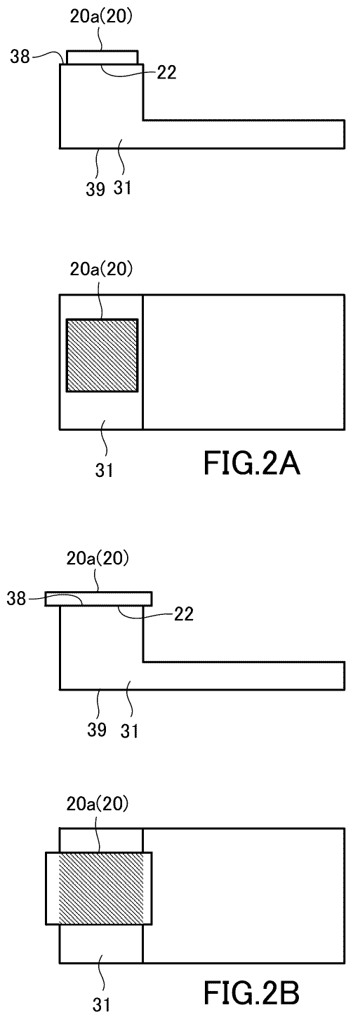

Here, an example of a region on the lower surface of the heat generation element 20 facing the upper surface 38 of the heat generation element pedestal 31 will be described. The upper part of FIG. 2A is a side view of the heat generation element pedestal 31 on which the heat generation element 20 is mounted. The lower part of FIG. 2A is a plan view of the upper part of FIG. 2A. The shaded region in the lower part of FIG. 2A shows a region facing the upper surface 38 of the heat generation element pedestal 31 on the lower surface 22 of the heat generation element 20 when the heat generation element pedestal 31 on which the heat generation element 20 is mounted is viewed in a plan view. This means that, in this example, the entire surface of the lower surface 22 of the heat generation element 20 is in contact with the upper surface 38 of the heat generation element pedestal 31.

FIG. 2B shows other example of the region of the lower surface of the heat generation element 20 facing the upper surface 38 of the heat generation element pedestal 31. The upper part of FIG. 2B is a side view of the heat generation element pedestal 31 on which the heat generation element 20 is mounted. The lower part of FIG. 2B is a plan view of the upper part of FIG. 2B. The shaded region in the lower part of FIG. 2B shows a region facing the upper surface 38 of the heat generation element pedestal 31 on the lower surface 22 of the heat generation element 20 when the heat generation element pedestal 31 on which the heat generation element 20 is mounted is viewed in a plan view. This means that, in this example, the entire surface of the lower surface 22 of the heat generation element 20 is not in contact with the upper surface 38 of the heat generation element pedestal 31, but only the region of the lower surface 22 of the heat generation element 20 facing the upper surface 38 of the heat generation element pedestal 31 is in contact with the upper surface 38 of the heat generation element pedestal 31.

The upper part of FIG. 1 shows a configuration in which the widths of the heat generation element pedestals 31 are generally the same, but the width of a portion of the heat generation element pedestal 31 on which the modulation element unit 10 is mounted may be narrower than the width of a portion on which the heat generation element 20 is mounted, as long as it is a size that the modulation element unit 10 can be mounted.

Further, when the thickness of the heat generation element 20 and the modulation element unit 10 differ from each other, a step 33 may be provided between the portion of the heat generation element pedestal 31 where the modulation element unit 10 is mounted and the portion where the modulation element unit 10 is mounted, so that the height of the upper surfaces of the heat generation element 20 and the modulation element unit 10 are the same. Electrode pads 62, 64 to which high-frequency electric signals are input/output are provided on the upper surfaces of the heat generation element 20 and the modulation element unit 10, and by setting the height of the step 33 so that the electrode pads of the heat generation element 20 and the modulation element unit 10 are located on the same plane, it is possible to reduce the performance degradation in the high frequency connection between the heat generation element 20 and the modulation element unit 10.

As described above, the optical device 1 according to the present embodiment can take a larger area in contact with the heat generation element pedestal 31 with the bottom wall 40e of the housing 40 that functions as the heat dissipating unit as compared to the conventional case since the heat generation element pedestal 31 is configured to extend below the modulation element unit 10. As a result, in the optical device 1 according to the present embodiment, the cross-sectional area of the heat transfer path from the heat generation element 20 as a heat source to the bottom wall 40e can be made larger than that of the conventional configuration, so that the heat generated by the heat generation element 20 can be efficiently dissipated to the outside of the housing 40.

Further, the optical device 1 according to the present embodiment can reduce the number of parts and the cost of parts since the heat generation element 20 and the modulation element unit 10 are configured to be mounted on the same heat generation element pedestal 31.

Further, since the optical device 1 according to the present embodiment has improved heat dissipation as compared to the conventional case, it is possible to increase the selection of materials used for the heat generation element pedestal 31. For example, it is possible to achieve heat dissipation equivalent to or better than that of conventional materials, even if a material having lower thermal conductivity than conventional materials but at a lower cost is selected. In addition, it is possible to improve the mechanical reliability of the device by selecting a material that takes into account the coefficient of linear expansion of the heat generation element and the housing.

Further, since the optical device 1 according to the present embodiment has excellent heat dissipation, even if a driver element 20a with a single-ended signal output having a large power consumption and heat generation amount is mounted, heat transfer can be reduced so that the adjacent modulation element unit 10 does not become hot, thereby making it possible to stably operate the modulation element unit 10.

### Second Embodiment

Subsequently, the optical device according to the second embodiment of the present invention will be described with reference to the drawings. It should be noted that the same components as those of the first embodiment are designated by the same reference numerals, and the description thereof will be omitted as appropriate.

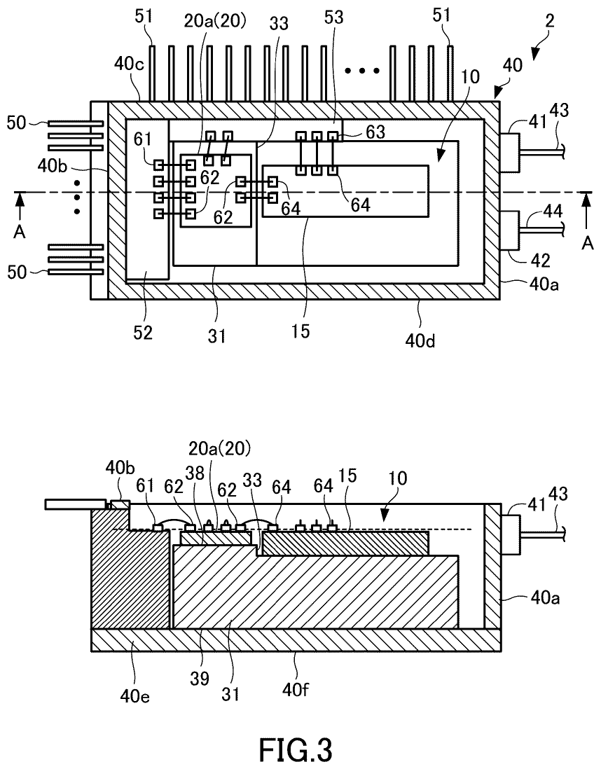

The upper part of FIG. 3 is a schematic plan view of the optical device 2 according to the second embodiment of the present invention. The lower part of FIG. 3 is a schematic cross-sectional view of the optical device 2 along the line A-A of the upper part of FIG. 3.

The optical device 2 shown in FIG. 3 is different from the optical device 1 of the first embodiment in the point that the modulation element unit 10 includes an optical modulation element 15 in which a Mach-Zehnder-type optical waveguide is formed on a substrate having an electro-optical effect.

The optical modulation element 15 in the present embodiment uses a dielectric material such as LN, lithium tantalate (LiTaO₃), or lead lanthanum zirconate titanate (PLZT), or a material having an electro-optical effect such as an EO polymer, as a substrate having an electro-optic effect. Further, it is also possible to use a substrate in which the electro-optical material is thinned to 10 μm or less on a base substrate constituted by other materials. In the optical modulation element 15, an optical waveguide through which light waves propagate and a modulation electrode for performing modulation and bias point control are formed on the substrate. Here, as the optical waveguide of the optical modulation element 15, for example, a rib type or rectangular type optical waveguide is used.

The coefficient of linear expansion α of LN is 14.0×10⁻⁶/K. Si, glass (SiO₂), and the like is used as the base substrate material, in the case that the substrate of the optical modulation element 15 is a thin film LN. The thin film LN can be achieved by joining the base substrate and the substrate having an electro-optic effect directly or via an adhesive layer, or by forming an electro-optical material on the base substrate. In the case that the refractive index of the base substrate is higher than that of the substrate having the electro-optical effect, a material having a refractive index lower than that of the substrate having the electro-optical effect is used as the adhesive layer, or a layer with a lower refractive index is provided in addition to an adhesive layer.

The optical modulation element 15 whose substrate is constituted by the above-mentioned dielectric material is characterized in that its modulation characteristics are not easily affected by temperature. Therefore, the modulation element unit 10 does not necessarily have to include the submount 12 or the temperature control element 13 included in the configuration of the first embodiment.

The driver element 20a is for driving the optical modulation element 15, and is connected to the electrode pad 64 of the optical modulation element 15 by means of such as metal wire bonding or flip chip bonding, for example. The driver element 20a is configured to amplify the externally input modulation signal and convert it into a modulation signal having a suitable intensity for providing to the optical modulation element 15. Further, in the case that a modulation element having a single-ended structure such as, for example, an X-plate LN modulator is used as the optical modulation element 15, the input differential signal may be converted into a single-ended signal by the driver element and output.

An optical input assembly 41 and an optical output assembly 42 are attached to the side wall 40a of the housing 40. An input optical fiber 43 for inputting light to the optical modulation element 15 is connected to the optical input assembly 41. An output optical fiber 44 that guides the light output from the optical modulation element 15 to the outside of the housing 40 is connected to the optical output assembly 42. In addition to the optical fiber, the optical input assembly 41 and the optical output assembly 42 include a lens for collimating and condensing light.

As described above, the optical device 2 according to the present embodiment can take a larger area in contact with the heat generation element pedestal 31 with the bottom wall 40e of the housing 40 that functions as the heat dissipating unit as compared to the conventional case since the heat generation element pedestal 31 is configured to extend below the modulation element unit 10. As a result, in the optical device 2 according to the present embodiment, the cross-sectional area of the heat transfer path from the heat generation element 20 as a heat source to the bottom wall 40e can be made larger than that of the conventional configuration, so that the heat generated by the heat generation element 20 can be efficiently dissipated to the outside of the housing 40.

Further, in the optical device 2 according to the present embodiment, since the optical modulation element 15 uses a dielectric material such as a thin film LN, it is not necessary to use the temperature control element 13 used in the first embodiment. Therefore, the optical device 2 according to the present embodiment can reduce the number of parts and the cost of parts since the pedestal of the heat generation element 20 and the optical modulation element 15 can be configured by the same heat generation element pedestal 31.

Further, since the optical device 2 according to the present embodiment has improved heat dissipation as compared to the conventional case, it is possible to increase the selection of materials used for the heat generation element pedestal 31. For example, it is possible to achieve heat dissipation equivalent to or better than that of conventional materials, even if a material having lower thermal conductivity than conventional materials but at a lower cost is selected. In addition, it is possible to improve the mechanical reliability of the device by selecting a material that takes into account the coefficient of linear expansion of the heat generation element and the housing.

Further, since the optical device 2 according to the present embodiment has excellent heat dissipation, even if a driver element 20a with a single-ended signal output having a large power consumption and heat generation amount is mounted, heat transfer can be reduced so that the adjacent modulation element unit 10 does not become hot, thereby making it possible to stably operate the modulation element unit 10.

### Third Embodiment

Subsequently, the optical device according to the third embodiment of the present invention will be described with reference to the drawings. It should be noted that the same components as those of the first and second embodiments are designated by the same reference numerals, and the description thereof will be omitted as appropriate.

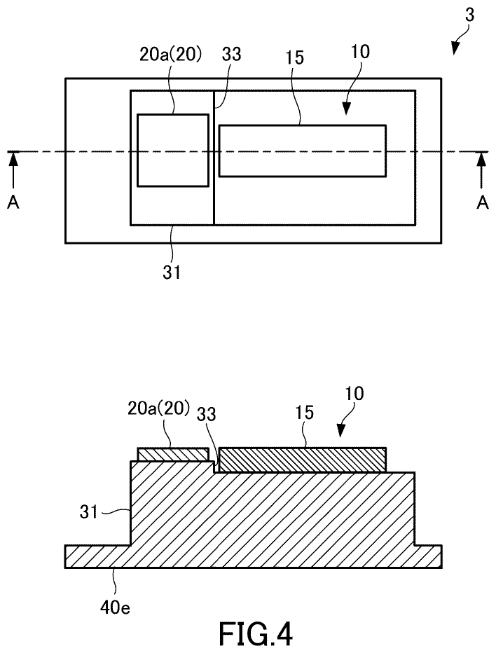

The upper part of FIG. 4 is a schematic plan view of the optical device 3 according to the third embodiment of the present invention. The lower part of FIG. 4 is a schematic cross-sectional view of the optical device 3 along the line A-A of the upper part of FIG. 4. It should be noted that in FIG. 4, the side walls 40a to 40d of the housing 40, the optical input assembly 41 and the optical output assembly 42, the input optical fiber 43 and the output optical fiber 44, and the relay boards 52 and 53 are not shown. Further, in the present embodiment, the case where the modulation element unit 10 includes the optical modulation element 15 in the second embodiment will be described as an example.

In the optical device 3 shown in FIG. 4, the bottom wall 40e of the housing 40 and the heat generation element pedestal 31 are integrated by the same material.

For example, as the material of the bottom wall 40e integrated and the heat generation element pedestal 31, copper (α: 14.3× 10⁻⁶/K, k: 398 W/m· K), aluminum (α: 24.58×10⁻⁶/K, k: 398 W/m· K), Aluminum (α: 24.58×10⁻⁶/K, k: 237 W/m· K), copper tungsten (α: 6.5×10⁻⁶/K, k: 170 W/m· K) and the like can be preferably used.

This means that, the optical device 3 according to the present embodiment can eliminate the need to join and fix the heat generation element pedestal 31 to the bottom wall 40e by integrating the bottom wall 40e that function as the heat dissipating unit and the heat generation element pedestal 31. Therefore, in addition to the effect of the second embodiment, the optical device 3 according to the present embodiment can more efficiently dissipate the heat generated by the heat generation element 20.

It should be noted that in the optical device of other embodiments, the heat generation element pedestal 31 may be integrated with the bottom wall 40e by the same material.

### Fourth Embodiment

Subsequently, the optical device according to the fourth embodiment of the present invention will be described with reference to the drawings. It should be noted that the same components as those of the first and second embodiments are designated by the same reference numerals, and the description thereof will be omitted as appropriate.

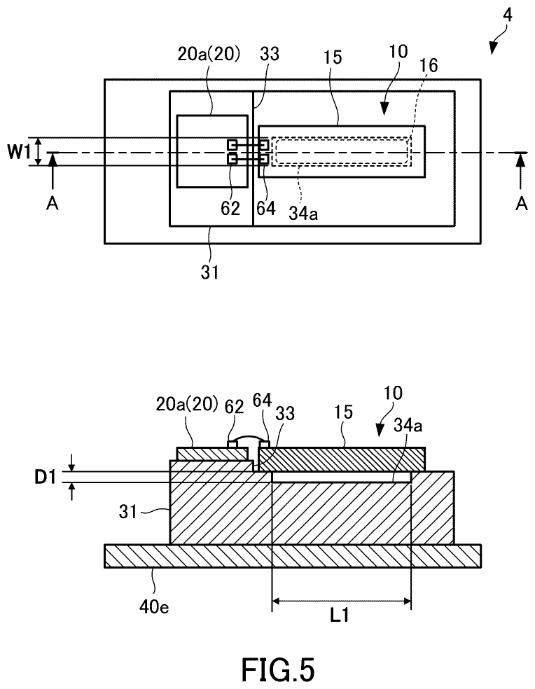

The upper part of FIG. 5 is a schematic plan view of the optical device 4 according to the fourth embodiment of the present invention. The lower part of FIG. 5 is a schematic cross-sectional view of the optical device 4 along the line A-A of the upper part of FIG. 5. It should be noted that in FIG. 5, the side walls 40a to 40d of the housing 40, the optical input assembly 41 and the optical output assembly 42, the input optical fiber 43 and the output optical fiber 44, and the relay boards 52 and 53 are not shown. Further, in the present embodiment, the case where the modulation element unit 10 includes the optical modulation element 15 in the second embodiment will be described as an example.

As shown in the first to third embodiments, in the case that the length of the heat generation element pedestal 31 on which the heat generation element 20 is mounted is extended to below the modulation element unit 10 along the longitudinal direction of the housing 40, the dissipation is improved over the conventional structure. However, the heat generated by the heat generation element 20 may be transferred to the modulation element unit 10 via the heat generation element pedestal 31 and affect the modulation characteristics of the optical modulation element 15. Therefore, the optical device 4 of the present embodiment is configured to be provided with a structure on the heat generation element pedestal 31 that makes it difficult for heat to be transferred to the optical modulation element 15 without impairing the heat dissipation of the heat generation element 20.

Specifically, as shown in FIG. 5, the heat generation element 20 is mounted on the heat generation element pedestal 31 so that the entire surface of the region facing the heat generation element pedestal 31 on the lower surface of the heat generation element 20 is in contact with the heat generation element pedestal 31. On the other hand, the modulation element unit 10 is mounted on the heat generation element pedestal 31 so that only a part of the modulation element unit 10 is in contact with the heat generation element pedestal 31.

A groove 34a formed by digging the upper surface of the heat generation element pedestal 31 is provided in a region including directly below the modulation unit 16 of the optical modulation element 15 on the upper surface side of the heat generation element pedestal 31. This means that the region of the lower surface of the modulation element unit 10 including the region directly below the modulation unit 16 does not contact with the heat generation element pedestal 31. By forming an air layer having high heat insulating properties between the groove 34a and the lower surface of the modulation element unit 10, it is possible to reduce the heat generated by the heat generation element 20 to be transferred to the modulation unit 16 of the optical modulation element 15. A configuration example of the modulation unit 16 will be described later.

The width W1 of the groove 34a should be at least the width of the modulation unit 16 of the optical modulation element 15, and should be as large as possible within the range in which the modulation element unit 10 can be mounted on the heat generation element pedestal 31, and may be larger than the optical modulation element 15. The length L1 of the groove 34a should be at least the length of the modulation unit 16 of the optical modulation element 15, and should be as large as possible within the range in which the modulation element unit 10 can be mounted on the heat generation element pedestal 31, and the length may exceed the optical modulation element 15 on the side away from the heat generation element 20. The deeper the depth D1 of the groove 34a is, the more heat transfer from the heat generation element 20 to the modulation unit 16 can be reduced, but if it is too deep, the improvement in heat dissipation is impaired. Therefore, the depth D1 of the groove 34a is preferably 0.2 mm or more, and is preferably up to about half the height of the heat generation element pedestal 31.

Further, the electrode pad 64 of the optical modulation element 15 is connected to the electrode pad 62 of the driver element 20a, or to the electrode pad 63 of the relay board 53 built into the housing 40 or integrated with the side wall 40c by ultrasonic crimping by means of such as wire bonding. In order to ensure the reliability of the damage of the optical modulation element 15 and the bonding strength at the time of bonding connection, it is desirable not to provide the groove 34a at least in the region facing the lower surface of the electrode pad 64 on the upper surface side of the heat generation element pedestal 31.

Here, the modulation unit 16 of the optical modulation element 15 refers to the Mach-Zehnder structure unit of the optical waveguide of the optical modulation element 15.

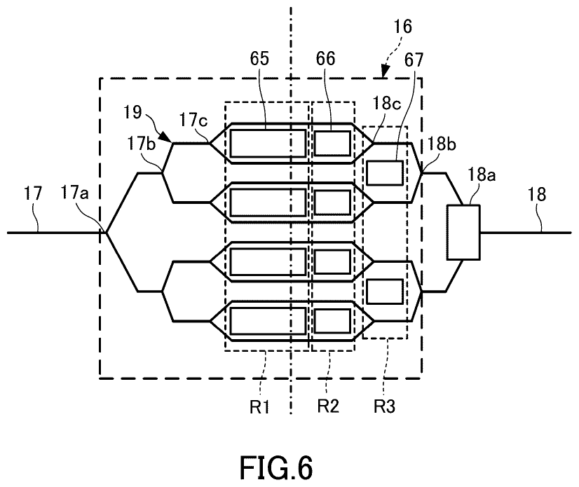

FIG. 6 shows an example of the optical modulation element 15 and the modulation unit 16. The modulation unit 16 is formed by integrating a plurality of Mach-Zehnder-type optical waveguides. An optical waveguide in which a plurality of Mach-Zehnder-type optical waveguides are combined is also called a nested optical waveguide. The modulation unit 16 in which a plurality of Mach-Zehnder-type optical waveguides are integrated is configured to be able to generate optical signals corresponding to various modulation methods. As an example, FIG. 6 shows a modulation unit 16 in which a plurality of Mach-Zehnder-type optical waveguides used in a polarization synthesis type modulator used for coherent communication are integrated, but the present invention is not limited to this structure, and it may be, for example, a modulation unit 16 having a single Mach-Zehnder type optical waveguide.

Further, the structure shown in the figure has a configuration in which an incoming waveguide 17 into which an optical signal is introduced from the outside and an outgoing waveguide 18 for outputting an optical signal to the outside are arranged in a linear direction, however, the incoming waveguide 17 and the outgoing waveguide 18 may be configured to be arranged in parallel with each other, or the extending direction of the incoming waveguide 17 and angle between the direction of extension of the incoming waveguide 17 and the direction of extension of the outgoing waveguide 18 is 90°. These configurations can be achieved by, for example, folding back 90° or 180° in the middle of the incoming waveguide 17 or the outgoing waveguide 18, or folding back 90° or 180° in the middle of the Mach-Zehnder type modulation unit 16 shown by the alternate long and short dash line in FIG. 6.

The modulation unit 16 comprises a first branch unit 17a that branches the incoming waveguide 17 into which an optical signal is introduced from the outside, a second branch unit 17b that further branches the optical waveguide 19 branched by the first branch unit 17a, and a third branch unit 17c that further branches the optical waveguide 19 branched by the second branch unit 17b, so that a total of eight parallel waveguides are formed through three-step branching. The first to third branch units 17a to 17c are achieved by optical couplers, a Y branch structure, and the like.

The phase of the light waves propagating in each parallel waveguide is adjusted, for example, in the region R1. A metal modulation electrode 65 (only the signal electrode at the time of single-ended drive is shown as an example in FIG. 6) is formed in each Mach-Zehnder structure of the region R1, and each parallel waveguide is applied with the electric field from the external signal source via the modulation electrode 65, so that the refractive index in the optical waveguide 19 changes and the light waves are modulated. A terminating resistance portion is connected to the output side of the modulation electrode 65, and a high frequency signal is terminated. The configuration of the modulation electrode 65 is appropriately selected depending on the type of the modulator to be used.

The light waves propagating in each parallel waveguide are synthesized in the second and third synthesis units 18b and 18c corresponding to each of the second and third branch units 17b and 17c described above. The modulated lights synthesized in the second and third synthesis units 18b and 18c are polarization rotated and polarization synthesized via the polarization synthesis unit 18a, and then output from the outgoing waveguide 18. Specifically, the modulation unit 16 shown in FIG. 6 is provided with a third synthesis unit 18c that synthesizes the parallel waveguides branched by the third branch unit 17c and a second synthesis unit 18b that synthesizes the optical waveguides 19 branched by the second branch unit 17b, and the light wave undergoes two-step synthesis, then the polarization synthesizing is performed by the polarization synthesizing unit 18a, and the light wave is output from the outgoing waveguide 18. Similar to the first to third branch units 17a to 17c, the second to third synthesis units 18b to 18c are also achieved by optical couplers, a Y branch, and the like. The polarization synthesizing unit can be achieved by using an optical component constituted by a wave plate, a polarization beam synthesizer, and the like. Further, the polarization synthesizing unit can be achieved by using a waveguide type element instead of an optical component, and in this case, it can be integrated in the optical modulation element 15.

It should be noted that the optical waveguide 19 shown in FIG. 6 is an example, and the present invention is not limited thereto.

Further, in order to obtain a desired optical modulation signal, a bias voltage for setting an operating point of each Mach-Zehnder structure of the modulation unit 16 is applied to the optical waveguide 19. The bias voltage is applied from an external signal source via, for example, bias electrodes 66, 67 formed in the region R2 or region R3 (FIG. 6 shows only the center electrode when the electrodes are arranged between the waveguides, as an example). Similar to the modulation electrode 65, the configurations of the bias electrodes 66 and 67 are appropriately selected depending on the type of the modulator. The application of the bias voltage can be achieved by forming a heater type electrode and adjusting the optical phase using the thermo-optical effect, in addition to the optical phase adjustment using the electro-optic effect.

It should be noted that the optical modulation element 11 or the optical modulation element 15 of the optical device of other embodiments may also have the configuration of the modulation unit 16 as shown in FIG. 6.

As described above, the optical device 4 according to the present embodiment is provided with a structure in which the modulation element unit 10 is mounted on the heat generation element pedestal 31 so that only a part of the modulation element unit 10 is in contact with the heat generation element pedestal 31, thereby making it possible to reduce the area where the modulation element unit 10 is in contact with the heat generation element pedestal 31. Specifically, a groove 34a formed by digging the upper surface of the heat generation element pedestal 31 is provided around the modulation unit 16 of the optical modulation element 15. As a result, the optical device 4 according to the present embodiment can prevent the heat of the heat generation element 20 from being transferred to the optical modulation element 15, reduce the thermal influence to the modulation unit 16 of the optical modulation element 15, and stabilize the modulation characteristics of the optical modulation element 15, in addition to the effect of the second embodiment.

### Fifth Embodiment

Subsequently, the optical device according to the fifth embodiment of the present invention will be described with reference to the drawings. It should be noted that the same components as those of the first and second embodiments are designated by the same reference numerals, and the description thereof will be omitted as appropriate.

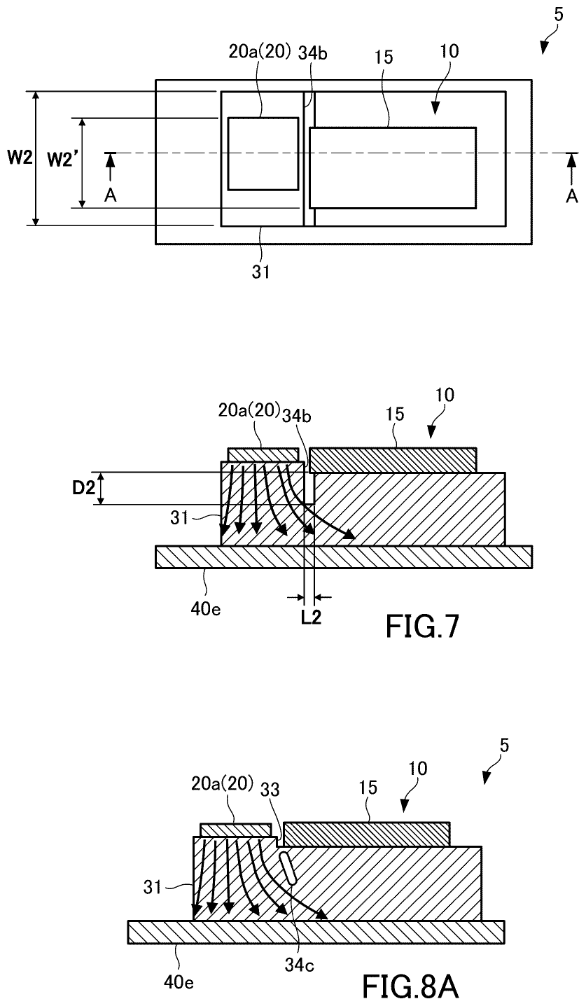

The upper part of FIG. 7 is a schematic plan view of the optical device 5 according to the fifth embodiment of the present invention. The lower part of FIG. 7 is a schematic cross-sectional view of the optical device 5 along the line A-A of the upper part of FIG. 7. It should be noted that in FIG. 7, the side walls 40a to 40d of the housing 40, the optical input assembly 41 and the optical output assembly 42, the input optical fiber 43 and the output optical fiber 44, and the relay boards 52 and 53 are not shown. Further, in the present embodiment, the case where the modulation element unit 10 includes the optical modulation element 15 in the second embodiment will be described as an example.

The optical device 5 of the present embodiment has a configuration in which at least one groove or hole for reducing heat transfer from the heat generation element 20 to the modulation element unit 10 is provided between the heat generation element 20 and the modulation element unit 10.

For example, as shown in FIG. 7, in the heat generation element pedestal 31, one or more grooves 34b are provided between the region where the heat generation element 20 is mounted and the region where the modulation element unit 10 is mounted.

The arrow in the heat generation element pedestal 31 in the lower part of FIG. 7 conceptually indicates the heat transfer direction from the heat generation element 20 to the heat generation element pedestal 31. In the heat generation element pedestal 31, the groove 34b is provided between the region where the heat generation element 20 is mounted and the region where the modulation element unit 10 is mounted, so that the heat transfer from the heat generation element 20 to the modulation element unit 10 via the heat generation element pedestal 31 can be reduced. It should be noted that it is desirable that no groove is provided in the lower part of the heat generation element 20 because it prevents the heat dissipation of the heat generation element 20.

It is desirable that the width W2 of the groove 34b is at least the spread W2′ in the width direction of the heat generation element pedestal 31 on the outer side edge of each of the heat generation element 20 and the modulation element unit 10 or more. The length L2 of the groove 34b is the length from the end of the region where the heat generation element 20 of the heat generation element pedestal 31 can be mounted to the end of the region where the modulation element unit 10 can be mounted. The deeper the depth D2 of the groove 34b is, the more heat transfer from the heat generation element 20 to the modulation element unit 10 can be reduced, but if it is too deep, the improvement of heat dissipation is impaired. Therefore, the depth D2 of the groove 34b is preferably 0.2 mm or more, and is preferably up to about half the height of the heat generation element pedestal 31.

It should be noted that although the lower part of FIG. 7 shows an example in which the groove 34b is provided along the vertical direction of the heat generation element pedestal 31, the present invention is not limited to this, and the groove 34b may be provided at a predetermined angle with respect to the vertical direction of the heat generation element pedestal 31, in order to secure a wide cross-sectional area of the heat transfer path from the heat generation element 20 to the bottom wall 40e.

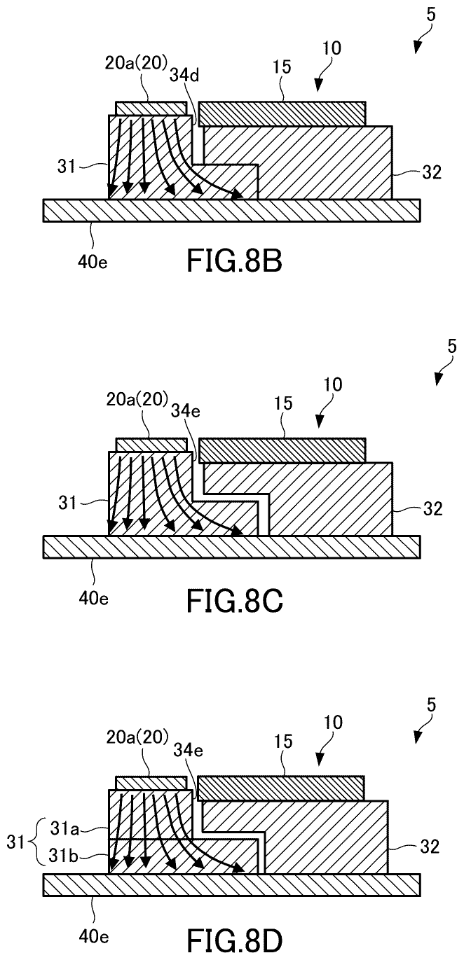

FIG. 8A is a schematic cross-sectional view showing other configuration example of the optical device 5, showing an example in which a hole 34c is provided at a predetermined angle with respect to the vertical direction of the heat generation element pedestal 31, in order to reduce heat transfer from the heat generation element 20 to the modulation element unit 10.

The arrow in the heat generation element pedestal 31 in FIG. 8A conceptually indicates the heat transfer direction from the heat generation element 20 to the heat generation element pedestal 31. In the heat generation element pedestal 31, one or more holes 34c along the heat transfer direction from the heat generation element 20 to the heat generation element pedestal 31 are provided between the region where the heat generation element 20 is mounted and the region where the modulation element unit 10 is mounted, so that the heat transfer from the heat generation element 20 to the modulation element unit 10 via the heat generation element pedestal 31 can be reduced.

The hole 34c is formed, for example, by drilling a hole from the side of the heat generation element pedestal 31 with a drill, a laser, and the like. It should be noted that the hole 34c may be provided at least over the spread W2′ as shown in the upper part of FIG. 7, and does not necessarily have to penetrate the heat generation element pedestal 31.

FIG. 8B is a schematic cross-sectional view showing other configuration examples of the optical device 5, and shows an example in which the heat generation element pedestal 31 and the modulation element unit pedestal 32 are provided as separate pedestal units. The modulation element unit 10 is mounted on the modulation element unit pedestal 32, and the heat generation element pedestal 31 extends below the modulation element unit 10. Here, the fact that the heat generation element pedestal 31 extends below the modulation element unit 10 means that at least a part of the modulation element unit 10 and the heat generation element pedestal 31 are overlapped, when the heat generation element pedestal 31 and the modulation element unit pedestal 32 on which the modulation element unit 10 is mounted is viewed in a plan view. A groove 34d is provided between the heat generation element pedestal 31 and the modulation element unit pedestal 32.

The heat generation element 20 is in contact with the heat generation element pedestal 31 on the entire surface of the region facing the heat generation element pedestal 31 on the lower surface of the heat generation element 20. On the other hand, in the modulation element unit 10, only a part of the modulation element unit 10 may be in contact with the modulation element unit pedestal 32.

The arrow in the heat generation element pedestal 31 in FIG. 8B conceptually indicates the heat transfer direction from the heat generation element 20 to the heat generation element pedestal 31. The heat generation element pedestal 31 is joined and fixed to the bottom wall 40e of the housing 40. Here, the heat generation element pedestal 31 can be joined and fixed to the bottom wall 40e by various methods such as welding, soldering, brazing, and bonding with a high heat conductive resin.

On the other hand, the fixing of the modulation element unit pedestal 32 to the bottom wall 40e does not need to be a fixing method having high heat transfer as used in the heat generation element pedestal 31, so that various adhesive fixing methods can be used. For example, it can be performed by using a resin-based adhesive. Since the thermal conductivity of the resin-based adhesive is lower than that of metals and the like, it is easy to reduce the transfer of the heat that was generated by the heat generation element 20 to the modulation element unit pedestal 32 and the modulation element unit 10 via the heat generation element pedestal 31 by adhesive fixing such as resin-based adhesive. Further, by adhering and fixing the heat generation element pedestal 31 and the modulation element unit pedestal 32 at their contact portions, heat transfer from the heat generation element 20 to the modulation element unit pedestal 32 and the modulation element 10 through the heat generation element pedestal 31 can be further reduced.

Alternatively, the heat generation element pedestal 31 may be integrated with the bottom wall 40e by the same material. Similarly, the modulation element unit pedestal 32 may be integrated with the bottom wall 40e by the same material.

Further, it is preferable for efficient heat dissipation from the heat generation element 20 to the bottom wall 40e that the bottom wall 40e and the heat generation element pedestal 31 are constituted of a metal material having higher thermal conductivity than that of the modulation element unit pedestal 32.

Further, the material of the heat generation element pedestal 31 is preferably a material with the coefficient of linear expansion closer to that of the heat generation element 20 than the bottom wall 40e. Similarly, the material of the modulation element unit pedestal 32 is preferably a material with the coefficient of linear expansion closer to that of the optical modulation element 15 than the bottom wall 40e of the housing 40. As a result, it possible to prevent the optical modulation element 15 from being damaged due to the difference in the coefficient of linear expansion when the temperature changes.

FIG. 8C is a schematic cross-sectional view showing other configuration example of the optical device 5, and shows an example in which the heat generation element pedestal 31 and the modulation element unit pedestal 32 are provided as separate pedestal units separated from each other. The modulation element unit 10 is mounted on the modulation element unit pedestal 32, and the heat generation element pedestal 31 extends below the modulation element unit 10. Here, the fact that the heat generation element pedestal 31 extends below the modulation element unit 10 means that at least a part of the modulation element unit 10 and the heat generation element pedestal 31 are overlapped, when the heat generation element pedestal 31 and the modulation element unit pedestal 32 on which the modulation element unit 10 is mounted is viewed in a plan view. A gap 34e is provided between the heat generation element pedestal 31 and the modulation element unit pedestal 32.

The heat generation element 20 is in contact with the heat generation element pedestal 31 on the entire surface of the region facing the heat generation element pedestal 31 on the lower surface of the heat generation element 20. On the other hand, in the modulation element unit 10, only a part of the modulation element unit 10 may be in contact with the modulation element unit pedestal 32.

The arrow in the heat generation element pedestal 31 in FIG. 8C conceptually indicates the heat transfer direction from the heat generation element 20 to the heat generation element pedestal 31. Similar to the configuration shown in FIG. 8B, the heat generation element pedestal 31 is joined and fixed to the bottom wall 40e. On the other hand, the modulation element unit pedestal 32 does not necessarily have to be joined and fixed to the bottom wall 40e, and may be adhesively fixed to the bottom wall 40e, as in the configuration shown in FIG. 8B.

Alternatively, the heat generation element pedestal 31 may be integrated with the bottom wall 40e by the same material. Similarly, the modulation element unit pedestal 32 may be integrated with the bottom wall 40e by the same material.

Further, the modulation element unit pedestal 32 may be constituted of a material having lower thermal conductivity than that of the bottom wall 40e and the heat generation element pedestal 31. In this case, it is possible to efficiently dissipate heat from the heat generation element 20 to the bottom wall 40e while preventing heat transfer to the optical modulation element 15 side.

Further, the material of the heat generation element pedestal 31 is preferably a material with the coefficient of linear expansion closer to that of the heat generation element 20 than the bottom wall 40e. Similarly, the material of the modulation element unit pedestal 32 is preferably a material with the coefficient of linear expansion closer to that of the optical modulation element 15 than the bottom wall 40e.

In the optical device 5 having the configuration shown in FIG. 8C, the heat generation element pedestal 31 and the modulation element unit pedestal 32 are provided as separate pedestal units separated from each other, so that it is possible to further reduce the transfer of heat from the heat generation element 20 to the modulation element unit pedestal 32 and the modulation element unit 10 via the heat generation element pedestal 31.

FIG. 8D is a schematic cross-sectional view showing other configuration example of the optical device 5, and similar to the configuration of FIG. 8C, and shows an example in which the heat generation element pedestal 31 and the modulation element unit pedestal 32 are provided as separate pedestal units separated from each other. The modulation element unit 10 is mounted on the modulation element unit pedestal 32, and the heat generation element pedestal 31 extends below the modulation element unit 10. Here, the fact that the heat generation element pedestal 31 extends below the modulation element unit 10 means that at least a part of the modulation element unit 10 and the heat generation element pedestal 31 are overlapped, when the heat generation element pedestal 31 and the modulation element unit pedestal 32 on which the modulation element unit 10 is mounted is viewed in a plan view. A gap 34e is provided between the heat generation element pedestal 31 and the modulation element unit pedestal 32.

The heat generation element 20 is in contact with the heat generation element pedestal 31 on the entire surface of the region facing the heat generation element pedestal 31 on the lower surface of the heat generation element 20. On the other hand, in the modulation element unit 10, only a part of the modulation element unit 10 may be in contact with the modulation element unit pedestal 32.

By the way, if there is a large difference between each of the coefficients of linear expansion of the heat generation element 20, the heat generation element pedestal 31, and the bottom wall 40e, there is a risk that each component itself or the joint surface is damaged. In this case, it is preferable that the heat generation element pedestal 31 divided into a plurality of parts is used, and that the material for each pedestal unit is selected so that the coefficient of linear expansion of the heat generating element 20, each pedestal unit of the heat generating element pedestal 31 divided into a plurality of parts, and the bottom wall 40e gradually changes from the heat generating element 20 toward the bottom wall 40e. By setting the coefficient of linear expansion in this way, it is possible to prevent damage due to the difference in the coefficient of linear expansion.

In the configuration of the optical device 5 shown in FIG. 8D, the heat generation element pedestal 31 is divided into two parts, an upper heat generation element pedestal 31a and a lower heat generation element pedestal 31b. It should be noted that the number of divisions of the heat generation element pedestal 31 is not limited to this, and may be three or more divisions.

It is desirable that the coefficient of linear expansion of the heating element pedestal 31 is a value between the coefficient of linear expansion of the heating element 20 and the bottom wall 40e. Further, it is desirable that the material of the upper heat generation element pedestal 31a is a material with the coefficient of linear expansion closer to that of the heat generation element 20 than the material of the lower heat generation element pedestal 31b. On the other hand, it is desirable that the material of the lower heat generation element pedestal 31b is a material with the coefficient of linear expansion closer to that of the bottom wall 40e than the material of the upper heat generation element pedestal 31a. Further, it is desirable that the material of the modulation element unit pedestal 32 is a material with the coefficient of linear expansion closer to that of the optical modulation element 15 than the material of the heat generation element pedestal 31.

The arrow in the heat generation element pedestal 31 in FIG. 8D conceptually indicates the heat transfer direction from the heat generation element 20 to the heat generation element pedestal 31. The upper heat generation element pedestal 31a and the lower heat generation element pedestal 31b are joined and fixed to each other. Further, the lower heat generation element pedestal 31b is joined and fixed to the bottom wall 40e. On the other hand, the modulation element unit pedestal 32 does not necessarily have to be joined and fixed to the bottom wall 40e, and may be adhesively fixed to the bottom wall 40e, as in the configuration shown in FIG. 8B.

Alternatively, the lower heat generation element pedestal 31b may be integrated with the bottom wall 40e by the same material. Similarly, the modulation element unit pedestal 32 may be integrated with the bottom wall 40e by the same material.

Further, the modulation element unit pedestal 32 may be constituted of a material having a lower thermal conductivity than that of the bottom wall 40e and the heat generation element pedestal 31. In this case, it is possible to efficiently dissipate heat from the heat generation element 20 to the bottom wall 40e while preventing heat transfer to the optical modulation element 15 side.

As described above, the optical device 5 according to the present embodiment is so configured that a void such as a groove 34b, a groove 34d, a hole 34c, or a gap 34e is provided in a path through which heat is transferred from the heat generation element 20, and between the region of the heat generation element pedestal 31 where the heat generation element 20 is mounted and the region of the heat generation element pedestal 31 where the modulation element unit 10 is mounted, or between the heat generation element pedestal 31 and the modulation element unit pedestal 32. As a result, the optical device 5 according to the present embodiment can prevent the heat of the heat generation element 20 from being transferred to the optical modulation element 15, reduce the thermal influence to the modulation unit 16 of the optical modulation element 15, and effectively dissipate the heat generated by the heat generation element 20, while stabilizing the modulation characteristics of the optical modulation element 15, in addition to the effect of the second embodiment.

### Sixth Embodiment

Subsequently, the optical device according to the sixth embodiment of the present invention will be described with reference to the drawings. It should be noted that the same components as those of the first and second embodiments are designated by the same reference numerals, and the description thereof will be omitted as appropriate.

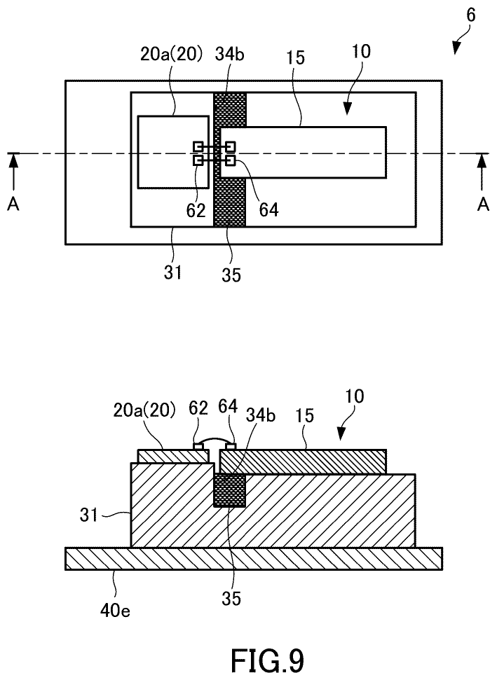

The upper part of FIG. 9 is a schematic plan view of the optical device 6 according to the sixth embodiment of the present invention. The lower part of FIG. 9 is a schematic cross-sectional view of the optical device 6 along the line A-A of the upper part of FIG. 9. It should be noted that in FIG. 9, the side walls 40a to 40d of the housing 40, the optical input assembly 41 and the optical output assembly 42, the input optical fiber 43 and the output optical fiber 44, and the relay boards 52 and 53 are not shown. Further, in the present embodiment, the case where the modulation element unit 10 includes the optical modulation element 15 in the second embodiment will be described as an example.

As described above, the electrode pad 64 of the optical modulation element 15 is connected to the electrode pad 62 of the driver element 20a by ultrasonic crimping by means of such as wire bonding. If there is a void at least in the region facing the lower surface of the electrode pad 64 on the upper surface side of the heat generation element pedestal 31, that is, in the lower part of the wire connecting portion, the energy of ultrasonic vibration escapes, so that the wire connection becomes difficult.

Therefore, the optical device 6 of the present embodiment is preferably configured that a material 35 having a lower thermal conductivity than that of the element pedestal 31 is arranged at a void such as the groove 34b provided between the region of the heat generation element pedestal 31 where the heat generation element 20 is mounted and the region of the heat generation element pedestal 31 where the modulation element unit 10 is mounted. The arrangement of the material 35 at the void such as the groove 34b is achieved by, for example, the material 35 being filled or coated in the void such as the groove 34b. As a result, the optical device 6 according to the present embodiment can efficiently transmit the energy of ultrasonic vibration at the time of wire connection to the electrode pad 64 of the optical modulation element 15. Examples of the void include the groove 34b shown in FIG. 7, the hole 34c shown in FIG. 8A, the groove 34d shown in FIG. 8B, the gap 34e shown in FIG. 8C, and the like.

As described above, the optical device 6 according to the present embodiment is so configured that a material 35 having a lower thermal conductivity than that of the element pedestal 31 is filled or coated at a void such as the groove 34b provided in a path through which heat is transferred from the heat generation element 20, and between the region of the heat generation element pedestal 31 where the heat generation element 20 is mounted and the region of the heat generation element pedestal 31 where the modulation element unit 10 is mounted. As a result, the optical device 6 according to the present embodiment can prevent the heat of the heat generation element 20 from being transferred to the optical modulation element 15, reduce the thermal influence to the modulation unit 16 of the optical modulation element 15, and stabilize the modulation characteristics of the optical modulation element 15, in addition to the effect of the second embodiment.

### Seventh Embodiment

Subsequently, the optical device according to the seventh embodiment of the present invention will be described with reference to the drawings. It should be noted that the same components as those of the first and second embodiments are designated by the same reference numerals, and the description thereof will be omitted as appropriate.

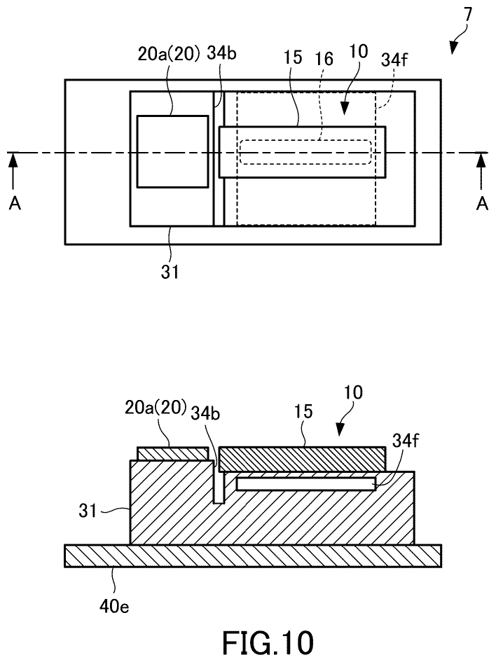

The upper part of FIG. 10 is a schematic plan view of the optical device 7 according to the seventh embodiment of the present invention. The lower part of FIG. 10 is a schematic cross-sectional view of the optical device 7 along the line A-A of the upper part of FIG. 10. It should be noted that in FIG. 10, the side walls 40a to 40d of the housing 40, the optical input assembly 41 and the optical output assembly 42, the input optical fiber 43 and the output optical fiber 44, and the relay boards 52 and 53 are not shown. Further, in the present embodiment, the case where the modulation element unit 10 includes the optical modulation element 15 in the second embodiment will be described as an example.

The optical device 7 of the present embodiment is configured to be provided with grooves and holes in a plurality of places of the heat generation element pedestal 31 as a structure to make it difficult for heat to be transferred from the heat generation element 20 to the optical modulation element 15.

For example, as shown in FIG. 10, one or more grooves 34b are provided between the region of the heat generation element pedestal 31 where the heat generation element 20 is mounted and the region of the heat generation element pedestal 31 where the modulation element unit 10 is mounted.

A hole 34f formed by drilling a hole from the side of the heat generation element pedestal 31 with a drill, a laser, and the like is provided in a region including directly below the modulation unit 16 of the optical modulation element 15 of the heat generation element pedestal 31. It should be noted that the hole 34f does not necessarily have to penetrate the heat generation element pedestal 31. By forming an air layer inside the hole 34f, it is possible to reduce the heat generated by the heat generation element 20 to be transferred to the modulation unit 16 of the optical modulation element 15.

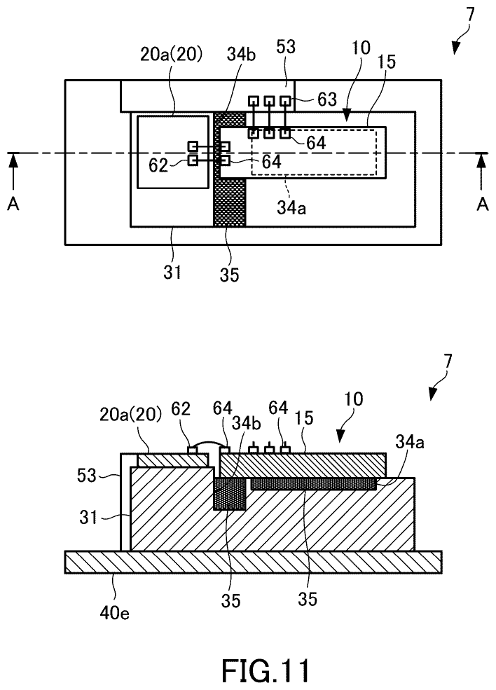

The upper part of FIG. 11 is a schematic plan view showing other configuration examples of the optical device 7. The lower part of FIG. 11 is a schematic cross-sectional view of the optical device 7 along the line A-A of the upper part of FIG. 11. It should be noted that in FIG. 11, the side walls 40a to 40d of the housing 40, the optical input assembly 41 and the optical output assembly 42, the input optical fiber 43 and the output optical fiber 44, and the relay board 52 are not shown.

For example, as shown in FIG. 11, one or more grooves 34b are provided between the region of the heat generation element pedestal 31 where the heat generation element 20 is mounted and the region of the heat generation element pedestal 31 where the modulation element unit 10 is mounted.

The heat generation element 20 is mounted on the heat generation element pedestal 31 so that the entire lower surface of the heat generation element 20 is in contact with the heat generation element pedestal 31. On the other hand, the modulation element unit 10 is mounted on the heat generation element pedestal 31 so that only a part of the modulation element unit 10 is in contact with the heat generation element pedestal 31.

Further, a groove 34a formed by digging down the upper surface of the heat generation element pedestal 31 is provided in a region including directly below the modulation unit 16 of the optical modulation element 15 on the upper surface side of the heat generation element pedestal 31.

As described above, the electrode pad 64 of the optical modulation element 15 is connected to the electrode pad 62 of the driver element 20a, or to the electrode pad 63 of the relay board 53 built into the housing 40 or integrated with the side wall 40c by ultrasonic crimping by means of such as wire bonding. If there is a void at least in the region facing the lower surface of the electrode pad 64 on the upper surface side of the heat generation element pedestal 31, that is, in the lower part of the wire connecting portion, the energy of ultrasonic vibration escapes so that the wire connection becomes difficult.

In the optical device 7 shown in FIG. 11, since the material 35 having a thermal conductivity lower than that of the heat generation element pedestal 31 is arranged in these grooves 34a and 34b, the heat generated by the heat generation element 20 can be reduced from being transferred to the modulation unit 16 of the optical modulation element 15 and at the same time, the energy of ultrasonic vibration at the time of wire connection can be efficiently transmitted to the electrode pad 64 of the optical modulation element 15. It should be noted that the arrangement of the material 35 in the grooves 34a and 34b is achieved by, for example, the material 35 being filled or coated in the grooves 34a and 34b.

As described above, the optical device 7 according to the present embodiment is so configured that a void such as a groove 34b or a hole 34f is provided in a path through which heat is transferred from the heat generation element 20, and between the region of the heat generation element pedestal 31 where the heat generation element 20 is mounted and the region of the heat generation element pedestal 31 where the modulation element unit 10 is mounted. Further, the optical device 7 of the present embodiment is so configured that a material 35 having a lower thermal conductivity than that of the element pedestal 31 is filled or coated with the material 35 at a void such as a groove 34a, a groove 34b, or a hole 34b provided in a path through which heat is transferred from the heat generation element 20, and between the region of the heat generation element pedestal 31 where the heat generation element 20 is mounted and the region of the heat generation element pedestal 31 where the modulation element unit 10 is mounted. As a result, the optical device 7 according to the present embodiment can prevent the heat of the heat generation element 20 from being transferred to the optical modulation element 15, reduce the thermal influence to the modulation unit 16 of the optical modulation element 15, and stabilize the modulation characteristics of the optical modulation element 15, in addition to the effect of the second embodiment.

### Eighth Embodiment

Subsequently, the optical device according to the eighth embodiment of the present invention will be described with reference to the drawings. It should be noted that the same components as those of the first and second embodiments are designated by the same reference numerals, and the description thereof will be omitted as appropriate.

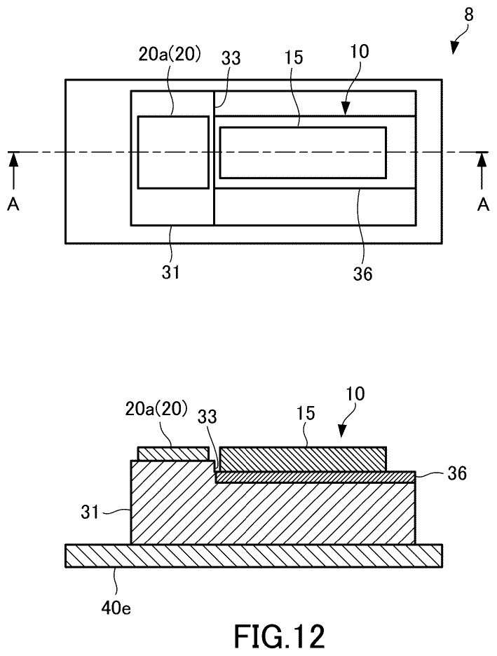

The upper part of FIG. 12 is a schematic plan view of the optical device 8 according to the eighth embodiment of the present invention. The lower part of FIG. 12 is a schematic cross-sectional view of the optical device 8 along the line A-A of the upper part of FIG. 12. It should be noted that in FIG. 12, the side walls 40a to 40d of the housing 40, the optical input assembly 41 and the optical output assembly 42, the input optical fiber 43 and the output optical fiber 44, and the relay boards 52 and 53 are not shown. Further, in the present embodiment, the case where the modulation element unit 10 includes the optical modulation element 15 in the second embodiment will be described as an example.

In the optical device 8 of the present embodiment is so configured that, in order to reduce the heat transfer from the heat generation element 20 to the optical modulation element 15 via the heat generation element pedestal 31, a component 36 constituted by a material having a lower thermal conductivity than that of the heat generation element pedestal 31 is arranged between the modulation element unit 10 and the heat generation element pedestal 31.

It should be noted that in the configuration in which the modulation element unit 10 is directly adhered to the heat generation element pedestal 31, if there is a large difference between the coefficient of linear expansion of the modulation element unit 10 and the coefficient of linear expansion of the heat generation element pedestal 31, there is a risk that the optical modulation element 15 is damaged or that the adhesive surface between the modulation element unit 10 and the heat generation element pedestal 31 is peeled off. In the optical device 8 of the present embodiment, since the component 36 is arranged between the modulation element unit 10 and the heat generation element pedestal 31, such a problem can be solved. In particular, as the material of the above component 36, it is desirable to use a material having a coefficient of linear expansion between the coefficient of linear expansion of the heat generating element pedestal 31 and the coefficient of linear expansion of the modulation element unit 10.

As described above, the optical device 8 according to the present embodiment is so configured that a material having a lower thermal conductivity than that of the heat generation element pedestal 31 is arranged between the modulation element unit 10 and the heat generation element pedestal 31. This means that the optical device 8 according to the present embodiment can prevent the heat of the heat generation element 20 from being transferred to the optical modulation element 15, reduce the thermal influence to the modulation unit 16 of the optical modulation element 15, and while stabilizing the modulation characteristics of the optical modulation element 15, effectively dissipate the heat generated in the heat generation element 20, since the component 36 constituted by a material having a lower thermal conductivity than that of the heat generation element pedestal 31 is inserted in the path where the heat is transferred from the heat generation element 20.

### Ninth Embodiment

Subsequently, the optical transmission apparatus according to the ninth embodiment of the present invention will be described with reference to the drawings. It should be noted that the same components as those of the first to eighth embodiments are designated by the same reference numerals, and the description thereof will be omitted as appropriate.

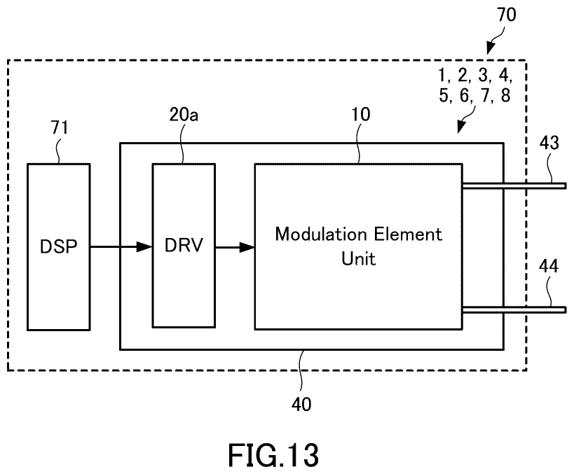

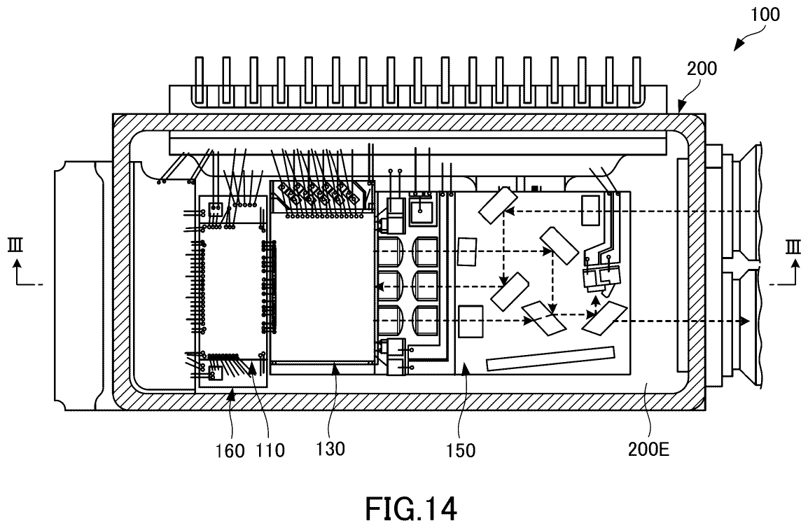

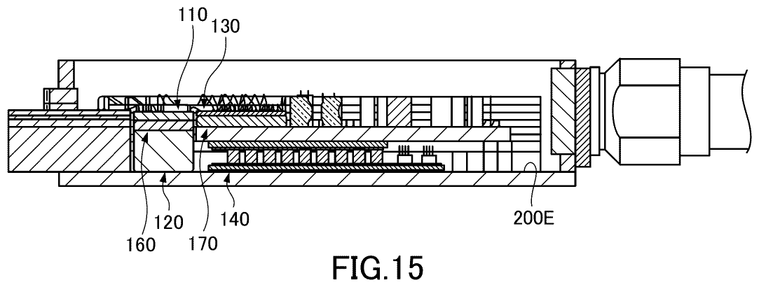

FIG. 13 shows a schematic configuration of an optical transmission apparatus 70 including any one of the optical devices 1 to 8 described in the above embodiment.

As described above, the optical devices 1 to 8 have the modulation element unit 10, the input optical fiber 43 and the output optical fiber 44 that input/output optical signals to the optical modulation element 11 or the optical modulation element 15 of the modulation element unit 10, and a driver element (DRV) 20a for amplifying a modulation signal input to the optical modulation element 11 or the optical modulation element 15 of the modulation element unit 10. The modulation element unit 10 and the driver element 20a are accommodated inside the housing 40.

The optical transmission apparatus 70 has any one of the optical devices 1 to 8 and a digital signal processor (DSP) 71 as an electronic circuit that outputs a modulation signal that causes the optical devices 1 to 8 to perform a modulation operation. The driver element 20a amplifies the modulation signal output from the DSP 71 and applies it to the optical modulation element 11 of the modulation element unit 10 or the modulation electrode 65 of the optical modulation element 15. The modulation signal output from the DSP 71 is input to the driver element 20a via, for example, the high frequency input terminal 50.

The driver element 20a and the DSP 71 can be arranged outside the housing 40, but can also be arranged inside the housing 40. In particular, by arranging the driver element 20a inside the housing 40, it is possible to further reduce the propagation loss of the modulated signal from the driver element 20a.

### EXPLANATION OF REFERENCE NUMERALS

1,2,3,4,5,6,7,8 Optical Device
10 Modulation Element Unit
11,15 Optical Modulation Element
12 Submount
13 Temperature Control Element
16 Modulation Unit
19 Optical Waveguide
20 Heat Generation Element
20a Driver Element
22 Bottom Surface
31, 31a, 31b Heat Generation Element Pedestal
32 Modulation Element Pedestal
33 Step
34a, 34b, 34d Groove
34c, 34f Hole
34e Gap
35 Material
36 Component
38 Top Surface
39 Bottom Surface
40 Housing
40a, 40b, 40c, 40d Side Wall
40e Bottom Wall
40f Bottom Surface
70 Optical Transmission Apparatus
71 DSP

What is claimed is:

1. An optical device, comprising:
a modulation element unit including an optical modulation element;
a heat generation element;
a heat generation element pedestal on which the heat generation element is mounted; and
a housing that accommodates the heat generation element pedestal inside there, wherein
the heat generation element pedestal has a mounting surface on which the heat generation element is mounted and a mounting surface to be mounted on the housing, and
the area of the mounting surface on which the heat generation element is mounted is smaller than the area of the mounting surface to be mounted on the housing.

2. The optical device according to claim 1, wherein
the modulation element unit is mounted on the heat generation element pedestal.

3. The optical device according to claim 1, wherein
the modulation element unit is mounted on a modulation element unit pedestal separate from the heat generation element pedestal.

4. The optical device according to claim 2, wherein
the heat generation element is mounted on the heat generation element pedestal so that the entire surface of the region facing the heat generation element pedestal on the lower surface thereof is in contact with the heat generation element pedestal, and
the modulation element unit is mounted so that a part thereof is in contact with the heat generation element pedestal.

5. The optical device according to claim 3, wherein
the heat generation element is mounted on the heat generation element pedestal so that the entire surface of the region facing the heat generation element pedestal on the lower surface thereof is in contact with the heat generation element pedestal, and
the modulation element unit is mounted so that a part thereof is in contact with the modulation element unit pedestal.

6. The optical device according to any one of claims 1 to 5, wherein
the heat generation element pedestal extends below the modulation element unit.

7. The optical device according to claim 2, wherein
in the heat generation element pedestal, one or more grooves or holes are provided between the region where the heat generation element is mounted and the region where the modulation element unit is mounted.

8. The optical device according to claim 3, wherein
one or more grooves or gaps are provided between the heat generation element pedestal and the modulation element unit pedestal.

9. The optical device according to claim 3, wherein
the heat generation element pedestal and the modulation element unit pedestal are separated from each other.

10. The optical device according claim 7, wherein
a material having a thermal conductivity lower than that of the heat generation element pedestal is arranged in the one or more grooves.

11. The optical device according to claim 2, wherein
a material having a thermal conductivity lower than that of the heat generation element pedestal is arranged between the modulation element unit and the heat generation element pedestal.

12. The optical device according to any one of claims 1 to 11, wherein
the heat generation element is a driver element for driving the optical modulation element.

13. The optical device according to any one of claims 1 to 3, wherein
the heat generation element pedestal is integrated with the bottom wall of the housing by the same material.

14. An optical transmission apparatus, comprising:
the optical device according to claim 12; and
an electronic circuit that outputs a modulation signal that causes the optical device to perform a modulation operation.
